(19) United States
(12) Patent Application Publication
(10) Pub. No.: US 2010/0301573 A1
(43) Pub. Date: Dec. 2, 2010

(54) Steerable Sledge Comprising Two Runners

(76) Inventor: Aurélien Mierswa, Mannheim (DE)

Correspondence Address: Horst M Kasper, 13 Forest Drive, Warren, NJ, 07059, US

(21) Appl. No.: 12/227,762

(22) PCT Filed: May 21, 2007
(86) PCT No.: PCT/EP2007/004494

§ 371 Date: Feb. 2, 2009

(30) Foreign Application Priority Data
May 25, 2006 (DE) 10 2006 024 926.7

(51) Int. Cl. B62B 13/08

(52) U.S. Cl. 280/16

(57) ABSTRACT

The invention relates to a steerable carriage comprising two runners (1, 1′) from which an upwardly oriented strut (2, 2′) respectively rises and between which a transversal cross member (17) extends in order to hold the runners (1, 1′). A seat part (10) is fixed to the transversal cross member and is supported on both sides of the runners (1, 1′) by the rear end (13) thereof, the front ends (7, 7′) of the runners being bent upwards. The transversal cross member (17) is connected to the struts (2, 2′) in an articulated manner just as the front end (37) of the seat part is held on the cross member in an articulated manner in such a way that it can be rotated about the central longitudinal axis (36) thereof in the centre of the cross member (17), the seat part (10) thus being able to be tilted along the central longitudinal axis thereof (36). In order to support the rear end (13) of the seat part (10) on the runners (1, 1′), the rear end regions of the runners respectively comprise a holding element (6) inside which or on which is respectively held a counter-holding element (14, 14′) arranged on its end on the rear end (13) of the seat part (10). The counter-holding elements (14, 14′) are arranged on the holding elements (6) fixed to the runners (1, 1′) in such a way that they can be rotated in relation to the holding elements or at least twisted thereon, whereby the end of the seat part (10) is rotatably suspended on the runners (1, 1′), at two suspension points, and the seat part is further suspended on the transversal cross member (17) in an articulated manner, at a front suspension point.

### FIELD OF THE INVENTION

The invention relates to a steerable sled comprising two runners, from each of which an upward oriented strut or wall rises and between which, in order to hold the runners, a transversal cross member extends to which a seat is attached which is supported on both sides in the area of its rear end on the runners that are curved upward, at least at their front ends, according to the generic part of claim 1.

### DESCRIPTION OF RELATED ART

There are numerous technical concepts for steerable sleds having only two runners. For example, it is a known approach to attach two flexible runners to two rotatable forks arranged one behind the other, whose axes of rotation—like with a bicycle—are slanted backward by a few angular degrees (forward position). By moving the two runners in opposite directions, they rotate around their longitudinal axes and steer the sled in a curve. In order to move the runners, there are two handgrips in the center and two U-shaped stirrups on the front ends of the runners for the placement of the feet. In order to move the runners relative to each other, riders have to exert pressure with their feet on one of the tips of the runners. This suppresses the bending of the runner. Thus, in a disadvantageous manner, it is only possible to execute turns with quite large radii. Moreover, the track width inevitably becomes narrower when the forks are twisted.

German patent application DE 10326588 A1 describes a sled having a seat frame designed with a special geometry. Said seat frame consists of a trapeze whose long side is at the top and that has a joint at each of the corners; two parts constructed according to this principle, one behind the other, form the seat frame, which can be tilted crosswise to the track. The upper transversal cross members support the seat. The runners are permanently attached to the support pillars of the seat frame, and so are the handgrips arranged to the left and right of the seat. When the seat frame is tilted, the runners rotate around their longitudinal axes. The runners are built like skis, that is to say, they are flexible around their crosswise axis. This sled has the obvious drawback that riders can only steer using the two handgrips by shifting their weight and leaning, as a result of which the sled reacts too “softly” and too “sensitively”, that is to say, even a slight leaning by the rider results in a tight curve so that the rider can easily be thrown off the sled at high speeds.

### Technical Objective

The invention is based on the objective of creating a steerable sled comprising two runners, with which especially tight curves can be taken without losing much speed, and changes in direction are made smoothly, similar to skiing. The sled should be easy to control and practical to carry, it should also be possible to design it with several seats, and the sled should be equally well-suited for different snow conditions.

### Achievement of the Objective and its Advantages

The objective is achieved with a sled of the above-mentioned type having the following features:
the transversal cross member is connected to the struts in an articulated manner,
in the area of its front end, the seat is held in the center of the transversal cross member in such a way that it can be rotated in an articulated manner around its longitudinal center axis, so that the seat can be tilted lengthwise around its longitudinal center axis,
in order to support the rear end of the seat on the runners, the runners each have a holder in the area of their rear ends, and a counter-holder that is arranged on each side at the rear end of the seat is held in or on said holder,
the counter-holders are arranged relative to the holders on the runners in such a way that said counter-holders can move rotationally or at least torsionally in or on said holders,
so that the seat is attached rotatably at its end on the runners at two attachment points, and at one front attachment point in an articulated manner on the transversal cross member.

The sled according to the invention has the advantage that, with this sled, especially curves can be taken in a controlled manner without losing much speed and changes in direction are made smoothly and quickly, similar to skiing or snowboarding. Normally, riders hold onto the left and right sides of the seat and steer the sled by shifting their weight to the right or left. By the same token, they can ride on the sled free-handed and steer it only with their feet. Moreover, the sled is easy to control, practical to carry since it is light in weight and it can also be configured as a two-seater. It has likewise been found that the sled according to the invention is equally well-suited for different snow conditions. The runners of the sled are preferably structured identically so that the sled is designed symmetrically to its vertical center plane. This ensures that the sled can be manufactured easily and inexpensively.

In another embodiment of the invention of the sled, the transversal cross member can be tilted three-dimensionally and is connected to the struts or to the wall so as to pivot elastically, whereby the seat is also held elastically in the center of the transversal cross member by an elastic cushioning member or by a ball bearing or cardan bearing so as to tilt around the longitudinal center axis of the seat and so as to pivot relative to said transversal cross member. In this manner, the transversal cross member can move upward or downward as well as forward and backward relative to the runners, and moreover, the seat is capable of executing a pivoting movement as well as a tilting movement around the longitudinal center axis. In another embodiment of the invention, the transversal cross member can be connected to the struts by means of two cardan joints arranged at the ends, whereby the seat is also held on the transversal cross member by means of a cardan joint so as to tilt. In particular, the transversal cross member is elastically movably connected to the struts and the seat is elastically movably connected to the transversal cross member.

In another embodiment of the sled, the elastic, movable connection of the transversal cross member to the struts consists of at least one elastic element between the ends of the transversal cross member and the struts, whereby the transversal cross member is held between the struts by means of a screw, such as a cap screw, that passes with play through a through hole in the struts and that is screwed into threaded holes in the transversal cross member.

In another embodiment of the sled, the elastic tilt-pivot connection of the seat relative to the transversal cross member consists of at least one elastic element between the seat and the transversal cross member, whereby the transversal cross member has a through hole in the center through which, as an axis, a screw, such as a cap screw, running in the direction of the longitudinal center axis of the seat passes, preferably with play, said screw being screwed into a threaded hole in the seat, whereby the threaded hole extends from the front end of the seat along the longitudinal center axis thereof.

In another embodiment, the struts are oriented so as to be oriented upward and forward at a slant, and they divide each of the runners into a front part and a rear part, whereby each of the end areas of the rear parts of the runners are angled upward at an angle β of more than 90° but less than 180°, thereby forming a turning and braking point in the transition between the rear parts of the runners and the end areas of the rear parts of the runners relative to the ground.

In another embodiment of the sled, the bolts arranged at the ends on the rear end of the seat are oriented upward at a slant at an angle α of 0° to 45° relative to the rear crosswise axis of the seat or to the rear part thereof, whereby the holders that are on the runners and that accommodate the bolts are slanted at an equal angle relative to the ground. Preferably, the bolts run in a perpendicular projection at a right angle relative to the longitudinal center axis of the seat.

In an advantageous embodiment of the sled according to the invention, in a perpendicular top view onto the runners, in order to hold the end of the seat in the backward direction, the holders of the runners are situated behind the turning and braking points of the runners, thereby forming a lever arm I between the turning and braking point and the holder; or else the holders can coincide with the end points of the runners.

In another embodiment of the sled, the runners—whose front ends are angled upward at a slant—are each bent back toward the struts so as to run upward at a slant in the form of a backward bend and they are integrally connected to the struts, whereby the connecting parts between the backward bends and the struts are configured as holding bars.

In another embodiment of the sled, the struts are oriented upward and facing inward toward each other, whereby the runners are likewise slanted with respect to each other in such a way that they only run on the inner edges of the runners.

In another embodiment of the sled, the struts as well as the runners are slanted toward each other at an angle α between 0° and 45° from the vertical, whereby the runners can be slightly convex in shape.

In another embodiment of the sled, the counter-holders are bolts that form the ends of a crosswise axis that extends at the rear part of the seat and that runs perpendicular to the longitudinal center axis thereof.

In another embodiment of the sled, the rear part of the seat is angled down toward the back in the form of an apron, whereby the bend runs in a perpendicular projection in the area of the turning and braking point of the runners or else in the area of the bends of the end areas.

In another embodiment of the sled, the runners and the seat, and optionally also the transversal cross member, are all made of a material containing carbon fibers or glass fibers or both.

Brief description of the drawing, in which the following is shown:

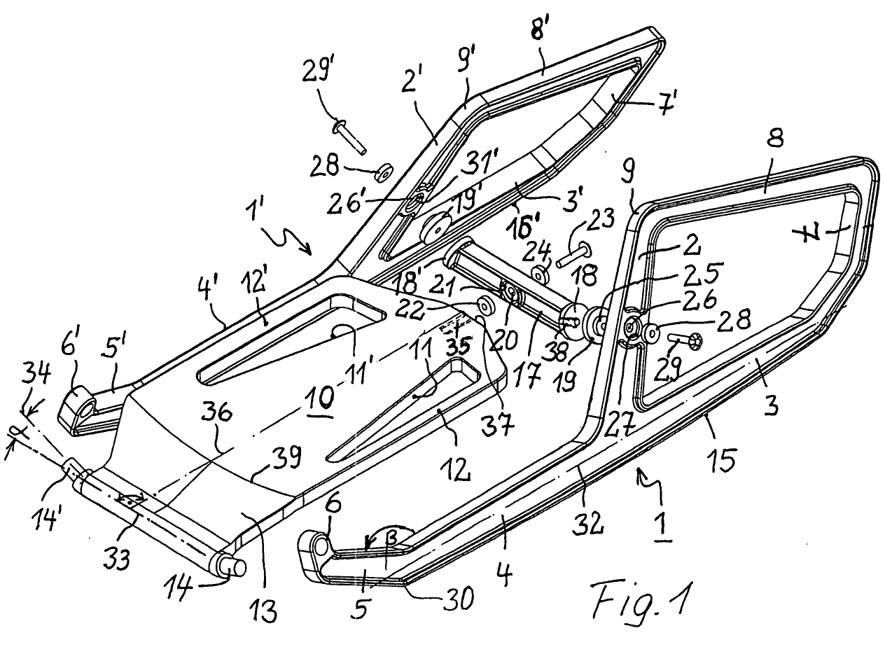

FIG. 1 a perspective exploded view of the sled according to the invention,

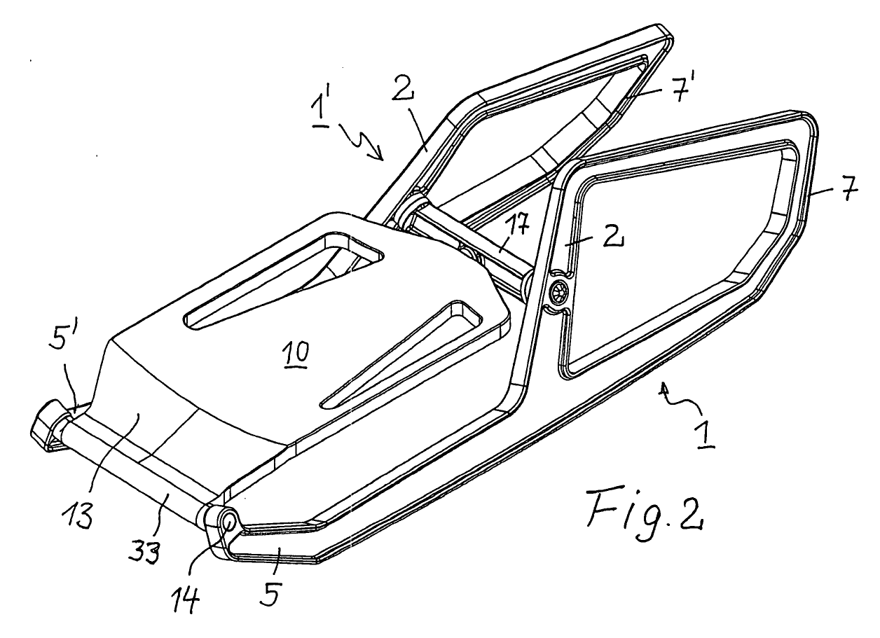

FIG. 2 a perspective view of the sled in the assembled state, as seen obliquely toward the seat,

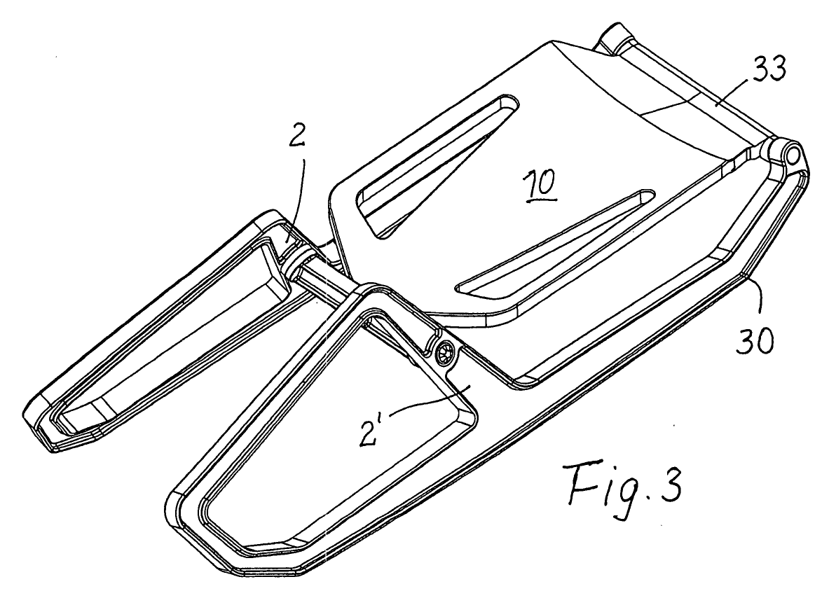

FIG. 3 another perspective view of the sled in the assembled state,

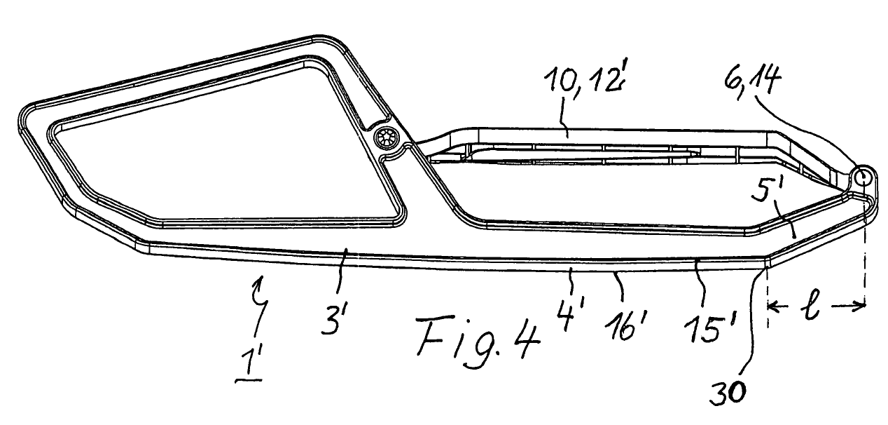

FIG. 4 a slightly oblique perspective side view of the sled in order to show the lever arm I for steering the sled,

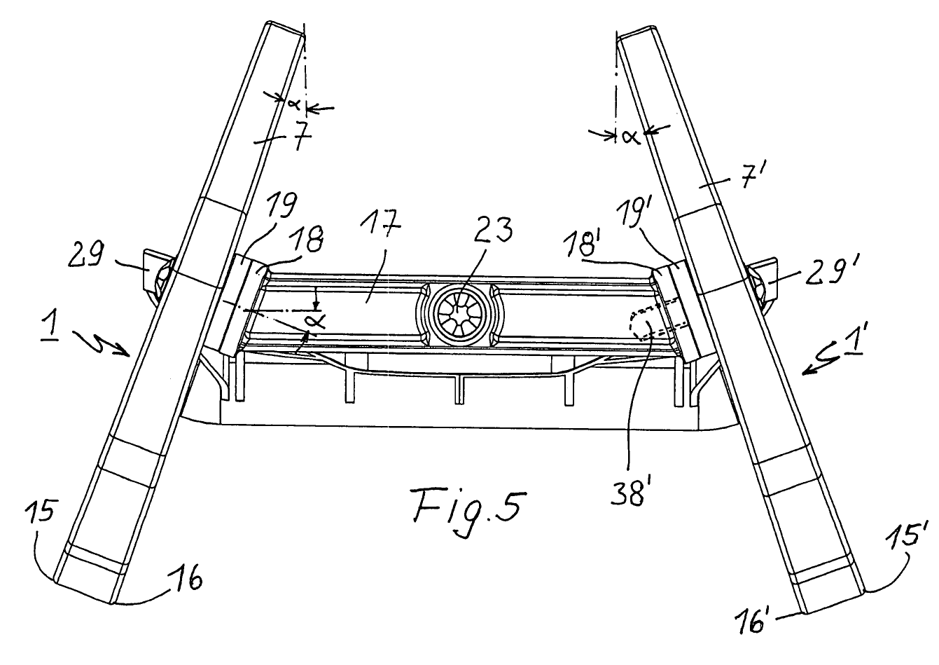

FIG. 5 a view of the sled from the front,

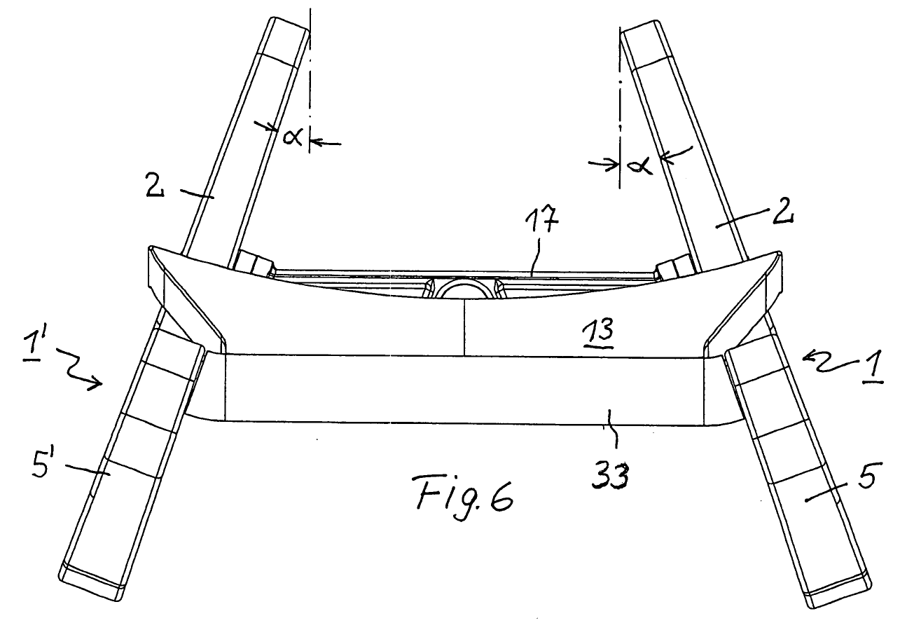

FIG. 6 a view of the sled from the back,

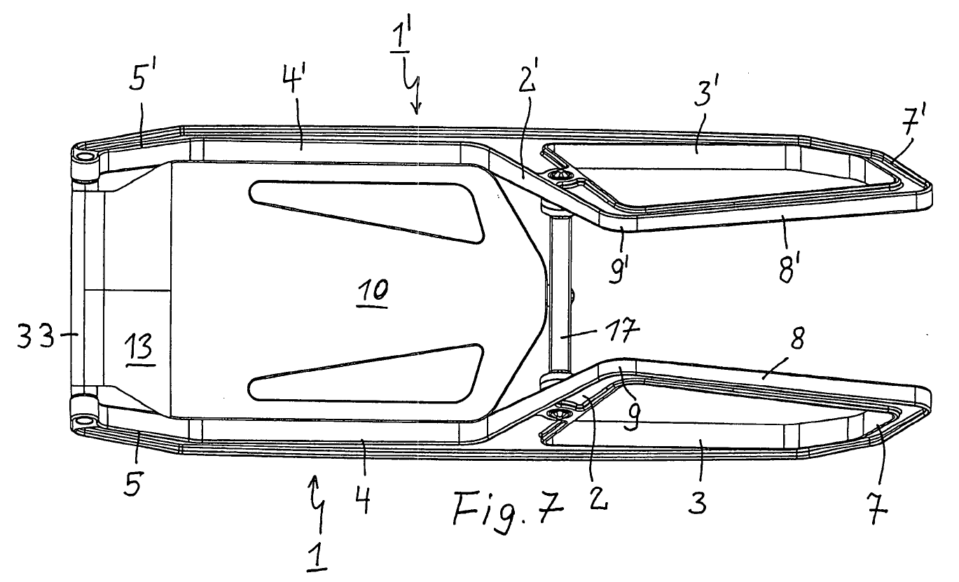

FIG. 7 a plan view of the sled from above,

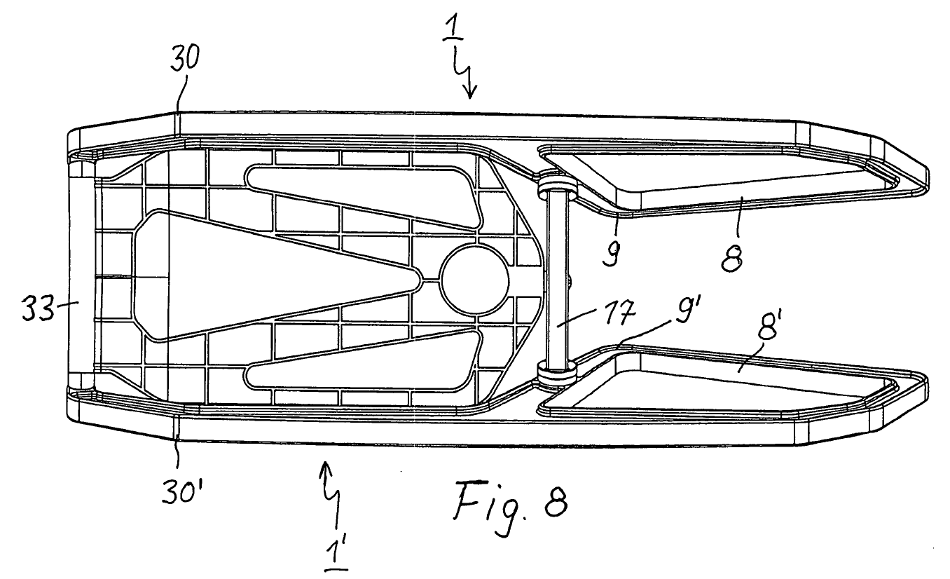

FIG. 8 a plan view of the sled from below,

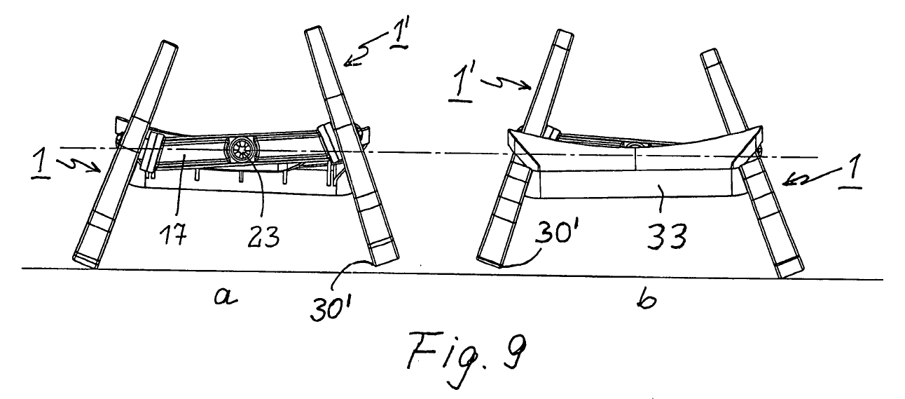

FIGS. 9a and b a view from the front and from the back of the sled as it makes a curve to the left,

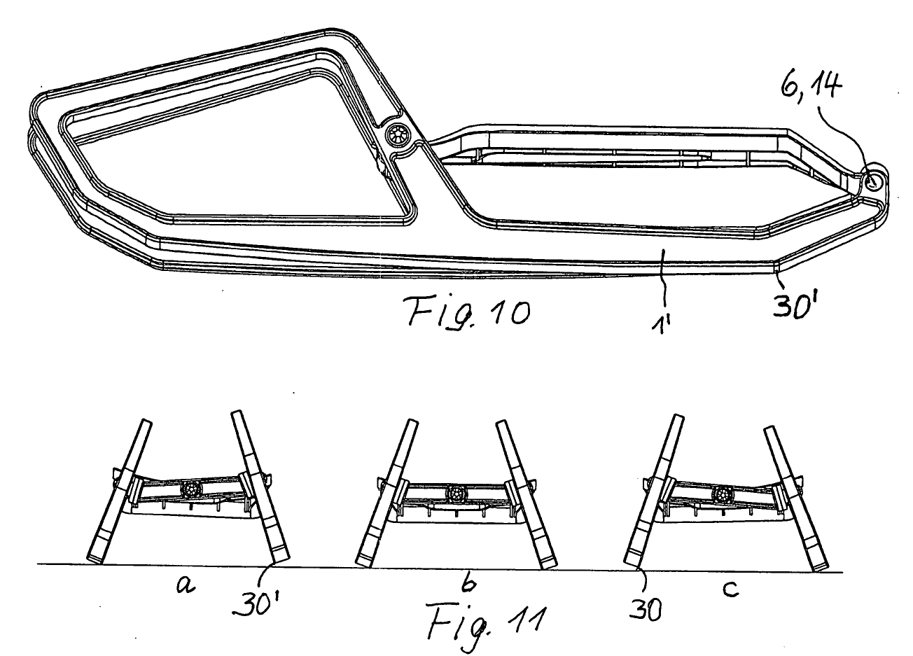

FIG. 10 a slightly oblique perspective view of the sled as it makes a curve to the left and,

FIGS. 11a, b and c a view from the front of the sled as it makes a curve to the left, as it rides straight ahead and as it makes a curve to the right.

An example of the invention is shown in the drawing and subsequently described. FIG. 1 shows a perspective exploded view of a steerable sled, comprising essentially two runners 1, 1′, from each of which an upward oriented strut 2, 2′ rises and between which a transversal cross member 17 extends in order to hold the runners 1, 1′. In the example shown, the struts 2, 2′ are oriented forward at a slant, whereby the struts 2, 2′ divide each of the runners 1, 1′ into a front part 3, 3′ and a rear part 4, 4′, and the front parts 3, 3′ of the runners 1, 1′ are curved upward at their front ends 7, 7′.

The front end 37 of a seat 10 is attached in the center to the transversal cross member 17; in the area of its rear end 13, the seat 10 is supported on both sides on the runners 1, 1′, namely, at the ends 5, 5′ of the rear part 4, 4′ of each runner 1, 1′.

The ends of the transversal cross member 17 are each connected to the struts 2, 2′ in an articulated and elastic manner, or else they are connected by means of an elastic joint. In the example shown, the transversal cross member 17 has a planar end 18, 18′ that functions as a support in each of which a threaded bore 38, 38′ extends in a centered position. The elastic connection of the transversal cross member 17 to the struts 2, 2′ consists, for example, of at least a first elastic element 19, 19′ resting on the planar ends 18, 18′ of the transversal cross member 17. The disk-shaped elastic elements 19, 19′ have centrally arranged second elastic elements 25, 25′ that have a smaller diameter, that are preferably likewise disk-shaped, and that here are integrally connected to the first elastic elements 19, 19′, for example, in one piece. The struts 2, 2′ each have a through hole 26, 26′, whereby, around the through hole 26, 26′, an inner blind hole 31, 31′ and an outer blind hole 27, 27′ are formed centrally in the struts 2, 2′ on the insides of the struts 2, 2′ as well as on the outsides thereof. Disk-shaped third elastic elements 28, 28′ are arranged inside the outer blind holes 27, 27′; the second elastic elements 25, 25′ of the first elastic elements 19, 19′ are located inside the inner blind holes 31, 31′. All of the elastic elements have a central through hole that is flush with the through holes 26, 26′ inside the struts 2, 2′. Starting from the outside of each of the struts 2, 2′, a cap screw 29, 29′ is inserted through all of the through holes of the elastic elements as well as through the through holes 26, 26′ inside the struts 2, 2′, said cap screw 29, 29′ being screwed into the appertaining threaded bore 38, 38′ inside the transversal cross member 17. Preferably, the shaft of the cap screw 29, 29′ has play inside the through hole 26, 26′, so that the cap screw 29, 29′ can move or tilt and pivot slightly inside the appertaining through hole 26, 26′, preferably three-dimensionally, whereby the elasticity of the elastic elements 19, 19′, 25, 25′, 28, 28′ exerts a restoring torque with respect to the struts 2, 2′ when the transverse crossbeam 17 tilts or pivots.

In the area of the front end 37 of the seat 10, which faces the transversal cross member 17 and which is preferably rigid or torsionally stiff, the seat 10 is rotatable around its longitudinal center axis 36 in an articulated manner in the center of the transversal cross member 17 and is held on or attached to said transversal cross member 17 in such a way that the seat 10 can be tilted along its longitudinal center axis 36.

The holder of the seat 10 can be such that a through hole 20 passes horizontally and through the center of the transversal cross member 17, whereby blind holes 21, 21′ are formed on both sides centered with respect to the through hole 20, an elastic disk 22, 24 being arranged in each of these blind holes 21, 21′. The elastic disks 22, 24 each have a centered through hole that is flush with the through hole 20 inside the transversal cross member 17. A cap screw 23 is inserted through all of the through holes of the elastic disks 22, 24 as well as through the through hole 20 starting from the side of the transversal cross member 17 that faces forward, said cap screw 23 being screwed into a threaded hole 35 inside the front end 37 of the seat 10. The threaded hole 35 extends along the longitudinal center axis 36 of the seat 10. Preferably, the shaft of the cap screw 23 has play inside the through hole 20, so that the cap screw 23 can move or tilt and pivot slightly inside the through hole 20, whereby the elasticity of the elastic disks 22, 24 exerts a restoring torque with respect to the transversal crossbeam 17 when the seat 10 tilts or pivots. Thus, the front end 37 of the seat 10 is attached rotatably around its center axis 36 as well as elastically, preferably three-dimensionally.

In order to support the rear end 13 of the seat 10 on the runners 1, 1′ on both sides, said runners 1, 1′ each have a holder 6 at the outer ends 5, 5′ of the rear parts 4, 4′, whereby each of said holders 6 can be a through hole 6 or a bearing. The rear end 13 of the seat 10 can be lowered or bent relative to the seat 10 itself—in the present example, it runs downward and backward at a slant in the form of an apron—whereby the end 13 of the seat 10 ends in a crosswise axis 33 that preferably runs perpendicular to the longitudinal center axis 36 of the seat 10. The ends of the crosswise axis 33 are configured as bolts 14, 14′ that are situated in the holders 6, 6′ or in the through holes 6, 6′ or in the bearings.

The bolts 14, 14′ can either be arranged rotatably in the holders 6, 6′ or else the bolts 14, 14′ can be secured tightly in the holders 6, 6′, whereby in this case, the axis 33 or else the bolts 14, 14′ arranged at the end can move torsionally with respect to the holders 6, 6′ of the runners 1, 1′. By the same token, the axis 33 can be held on both ends in an elastically movable manner on the ends 5, 5′ of the runners 1, 1′ or on the holders 6, 6′ or through holes 6, 6′ of the ends 5, 5′. It is essential that a rotational movement is possible, which can be small relative to the end 13 of the seat 10 vis-à-vis the runners 1, 1′. Preferably, the bolts 14, 14′ of the axis 33 run in a perpendicular projection at a right angle relative to the longitudinal center axis 36 of the seat 10. The runners 1, 1′, along with the front parts 3, 3′, the rear parts 4, 4′, as well as their ends 5, 5′ along with the holders 6, 6′, preferably lie in one plane.

Each of the ends 5, 5′ of the rear parts 4, 4′ of each runner 1, 1′ can be angled upward at an angle β of more than 90° but less than 180°—in the example shown, approximately 160°—thereby forming a turning and braking point 30, 30′ of the runners 1, 1′ relative to the ground, namely, between the transition between the rear parts 4, 4′ of each runner 1, 1′ toward the ends 5, 5′ of the runners 1, 1′.

The bend 39 of the rear part 13 of the seat 10 as seen in a perpendicular projection preferably runs in the area of the bend of the ends 5, 5′ of the rear parts 4, 4′ of the runners 1, 1′, said ends 5, 5′ being angled upward at a slant, or slightly behind that—which can be seen especially clearly in FIGS. 4 and 7—and consequently, during the ride, it runs through the area of the dynamic turning and braking points 30, 30′. The bend 39 of the seat 10 forms a delimitation of the seat surface of the seat 10 for the rider. This prevents the rider from sliding too far to the back on the seat 10. Since angled ends 5, 5′ of the rear parts 4, 4′ of the runners 1, 1′ are present, the result would be that the rider would cause the sled to tip onto the angled ends 5, 5′ of the rear parts 4, 4′ of the runners 1, 1′ which, of course, has to be prevented.

The above-mentioned attachment of the seat is thus designed in such a way that the seat is rotatably attached to the runners 1, 1′ at two rear attachment points and attached to the transversal cross member 17 so as to be articulated as well as preferably elastically at one front attachment point. The transversal cross member 17 is likewise connected to the struts 2, 2′ in such a way that it can be tilted and pivoted elastically. The seat 10 can be held elastically on the center of the transversal cross member 17 by an elastic cushioning member 22, 23, 24 or by a ball bearing or cardan bearing so as to tilt around the longitudinal center axis 36 of the seat 10 and also so as to pivot relative to said transversal cross member 17, so that the transversal cross member 17 is capable of moving relative to the runners 1, 1′ three-dimensionally upward or downward as well as forward and backward, and the seat 10 is capable of executing not only a tilting movement around the longitudinal center axis 36, but also a pivoting movement essentially in the main plane of the seat 10. However, the distance between the holders 6, 6′ is predefined by the rear part 13 of the seat 10 so that, between this part 13 and the holders 6, 6′ or the ends 5, 5′ of the runners 1, 1′, when the seat 10 tilts, the corresponding holder 6, 6′ is also forced downward and preferably only a rotational movement or torsion is possible inside the holder 6, 6′. The result is that the corresponding runner 1, 1′ is lifted upward and forward at a slant, so that the runner 1, 1′ essentially glides on its dynamic turning and braking points 30, 30′.

The movements executed by the parts that are movable with respect to each other have a relatively small deflection, but it is sufficiently large so that, when riders shift their weight while slightly lifting the corresponding runner 1, 1′ to a greater or smaller extent using the corresponding hand or foot, a curve can be executed to the left or to the right around the lifted runner.

The runners 1, 1′ of the sled are preferably arranged slanted at an angle α of 0° to 45°, preferably 30°, relative to each other as shown in FIGS. 5 and 6, so that the runners 1, 1′ mainly glide on their inner edges 16, 16′. Preferably, in this case, the struts 2,2′ are also slanted relative to each other at the same angle α from the vertical. Then, as can be seen especially clearly in FIGS. 1, 5 and 6, the bolts 14, 14′ that are arranged at the end on the rear end 13 of the seat 10 are also oriented upward and forward at a slant at an angle α relative to the crosswise axis 33 of the seat 10 since the holders 6, 6′ that are at the ends 5, 5′ of the runners 1, 1′ and that hold the bolts 14, 14′ are slanted at the same angle α with respect to the ground. By the same token, the planar ends 18, 18′ of the transversal cross member 17 are slanted at the same angle α with respect to the transversal cross member 17 since the struts 2, 2′ are slanted toward each other at this angle α.

Depending on the main area of use of the sled, namely, whether it is going to be used on ice or soft snow, the angle α can be wider (for ice) or narrower (for soft snow), so that the sled runs more or less only on the inner edges 16, 16′ of the runners 1, 1′ and the outer edges 15, 15′ face upward.

According to FIG. 1, the runners 1, 1′ of the sled, whose front ends 7, 7′ are bent upward at a slant, can each be bent back toward the struts 2, 2′ upward at a slant in the form of a reverse bend 8, 8′ and they can be integrally connected to the struts 2, 2′, whereby the connecting parts between the reverse bends 8, 8′ and the struts 2, 2′ are configured as holding bars 9, 9′.

Instead of the struts, it is also conceivable for walls that rise from the runners to be provided in the front area of the runners so that, in comparison to the design in FIG. 1, the front ends shown there, the reverse bends and the struts all form an integral wall that can be solid or else can have cutouts.

FIG. 4 also shows that the runners 1, 1′ can be slightly convex in shape. Furthermore, FIG. 4 especially shows the design of the runners 1, 1′ of the sled that brings about a particularly advantageous steering of the sled. As explained above, each runner 1, 1′ consists of a front part 3, 3′ and a rear part 4, 4′ whose rear end area 5, 5′ is angled slightly upward at an angle β, thereby forming a turning and braking point 30, 30′ of the runners 1, 1′ relative to the ground in the transition of the part 4, 4′ to the end area 5, 5′. As a result, between the turning and braking point 30, 30′ and the holder 6, 6′, a lever arm having the length l is formed on the outermost rear end of the end area 5, 5′ or of the runner 1, 1′ in a perpendicular direction in the projection, as can be seen in FIG. 4.

When the rider leans—in the example of FIG. 4—toward the left, the seat 10 rotates counterclockwise around the longitudinal center axis 36, whereby the left edge of the seat 10, and thus the left handgrip 12′ thereof, is lowered. Since the seat 10 is essentially torsionally stiff, the holding point 6′ is pushed downward. The holder 6′ is lowered at the outermost end of the runner 1′ so that the runner 1′ rotates around the turning point 30′ that functions, at the same time, as the braking point. The transmission ratio at which force the holding point 6′ is lowered in the direction of the ground is prescribed by the length l of the lever arm.

The turning and braking point 30, 30′ of the runners 1, 1′ can be shifted toward the back until it is underneath the holding point 6, 6′ of the end areas 5, 5′, but this has a negative effect on the steering characteristics of the sled.

It is also conceivable that the turning and braking point of the runners 1, 1′ coincides with the holding points 6, 6′ of the two ends of the seat 10 in the rear ends of the runners 1, 1′. As a result, the steering of the sled is still possible in an advantageous manner by pulling up one of the runners, for example, by pulling up one of the runners using a foot or hand, as a result of which the corresponding runner is rotated at its outermost rear end around the corresponding holding point. It is possible to pull up one of the runners since the entire sled is movably mounted in its joints.

FIGS. 9a and b show a view from the front and from the back of the sled as it makes a curve to the left. One can see that, in this case, the left-hand runner 1′ is lifted and, as a result, runs forward at a slant, as can be seen especially clearly in FIG. 10. During the ride in a curve to the left, the runner 1′ exerts the greatest pressure on the ground in the area of its dynamic turning and braking point 30′.

FIGS. 11 a, b and c show a view from the front of the sled as it makes a curve to the left, as it rides straight ahead and as it makes a curve to the right respectively. As it makes the curve to the left in FIG. 11a, the left runner 1′ is lifted and the sled turns around the dynamic turning and braking point 30, 30′ of this runner 1′; as it makes a curve to the right in FIG. 11c, the right runner 1 is lifted and the sled turns around the dynamic turning and braking point 30, 30′ of this runner 1.

The rider has the possibility to take the curves either by lifting the corresponding runner by means of the holding bars 9, 9′ using one hand, also with the assistance of the foot on that side, or else the rider holds onto the handgrips 12, 12′ of the seat and tilts it downward in the appropriate direction. If the seat 10 is tilted to the left—of course, assisted by the weight of the rider leaning to the left—then the left runner 1′ turns around its dynamic turning and braking point 30′ upward at a slant and the sled executes a curve to the left. The same applies accordingly to a curve to the right.

All of the bearing points of the sled, the rear holding points 6, 6′ of the seat 10 at the ends of the runners 1, 1′, the center front attachment point of the seat 10 on the transversal cross member 17 as well as the end attachment points of the transversal cross member on the struts 2, 2′ of the runners 1, 1′ can be elastic cushioning bearings such as rubber or plastic bearings, or ball bearings or cardan bearings or torsion bearings, which allow a reciprocal relative movement of the individual parts of the sled with respect to each other, preferably with restoring force.

### INDUSTRIAL APPLICABILITY

The invention is industrially applicable for the construction of sleds. The special configuration of the sled according to the invention lies in the fact that the four parts, namely, the runners 1, 1′, the transversal cross member 17 and the seat 10, can all move relative to each other by articulated connections—the three attachment points of the seat 10 and the two attachment points of the transversal cross member 17 to the struts 2, 2′.

### LIST OF REFERENCE NUMERALS

1, 1′ runners
2, 2′ struts
3, 3′ front parts of the runners
4, 4′ back parts of the runners
5, 5′ end areas of the back parts of the runners
6, 6′ holders or through holes on the rear end areas of the runners
   (torsion bearing or rotating bearing or ball bearing)
7, 7′ upward-bent ends of the front parts of the runners or bars
8, 8′ parts bent back on the upward-bent ends of the front parts of the runners
9, 9′ holding bars
10 seat
11, 11′ cutout
12, 12′ handgrips
13 rear part of the seat, apron
14, 14′ round bolts
15, 15′ outer edges of the runners
16, 16′ inner edges of the runners
17 transversal cross member
18, 18′ planar ends of the transversal cross member (support)
19, 19′, 25, 25′, 28, 28′ elastic elements
22, 24 elastic disks
20, 26, 26′ through holes
23, 29, 29′ cap screws
21, 21′, 27, 27′, 31, 31′ blind holes around the through holes
30, 30′ dynamic turning and braking points during the ride
32 longitudinal axis of the runners
33 crosswise axis of the rear part of the seat
34 longitudinal axis of the round bolts
35 threaded holes in the seat
36 longitudinal center axis in the plane of the seat
37 front end of the seat
38, 38′ threaded holes in the transversal cross member
39 bend
α angle of inclination of the struts relative to each other with respect to the vertical, as well as angle between the rear crosswise axis of the seat and the direction of the bolts
β angle between the runner and the end of the rear part of the runner

1. A steerable sled comprising two runners (1, 1′), from each of which an upward oriented strut (2, 2′) or wall rises and between which, in order to hold the runners (1, 1′), a transversal cross member (17) extends to which a seat (10) is attached which is supported on both sides in the area of its rear end (13) on the runners (1, 1′) that are curved upward, at least at their front ends (7, 7′),
characterized by the following features:
the transversal cross member (17) is connected to the struts (2, 2′) in an articulated manner,
in the area of its front end (37), the seat is held in the center of the transversal cross member (17) in such a way that it can be rotated in an articulated manner around its longitudinal center axis (36), so that the seat (10) can be tilted lengthwise around its longitudinal center axis (36),
in order to support the rear end (13) of the seat (10) on the runners (1, 1′), the runners (1, 1′) each have a holder (6, 6′) in the area of their rear ends, and a counter-holder (14, 14′) that is arranged on each side at the rear end (13) of the seat (10) is held in or on said holder (6, 6′),
the counter-holders (14, 14′) are arranged relative to the holders (6) on the runners (1, 1′) in such a way that said counter-holders (14, 14′) can move rotationally or at least torsionally in or on said holders (6),
so that the seat (10) is attached rotatably at its end on the runners (1, 1′) at two attachment points, and at one front attachment point in an articulated manner on the transversal cross member (17).

2. The sled according to claim 1, characterized in that
the transversal cross member (17) is connected to the struts (2, 2′) or to the wall so as to tilt and pivot elastically, whereby the seat (10) is also held elastically in the center of the transversal cross member (17) by an elastic cushioning member (22, 23, 24) or by a ball bearing so as to tilt around the longitudinal center axis (36) of the seat (10) and so as to pivot relative to said transversal cross member (17), so that the transversal cross member (17) can move three-dimensionally upward or downward as well as forward and backward relative to the runners (1, 1′), and moreover, the seat (10) is capable of executing a pivoting movement as well as a tilting movement around the longitudinal center axis (36).

3. The sled according to claim 1, characterized in that
the transversal cross member (17) is elastically movably connected to the struts (2, 2′) or to the walls and the seat (10) is elastically movably connected to the transversal cross member (17).

4. The sled according to claim 1, characterized in that
the transversal cross member (17) is connected to the struts (2, 2′) or to the walls by means of two cardan joints arranged at the ends, whereby the seat (10) is also held on the transversal cross member (17) by means of a cardan joint so as to tilt.

5. The sled according to claim 1 characterized in that
the elastic connection of the transversal cross member (17) to the struts (2, 2′) or to the walls consists of at least one elastic element (18, 18′, 19, 19′, 25, 25′, 28, 28′) between the ends of the transversal cross member (17) and the struts (2, 2′) or the walls, whereby the transversal cross member (17) is held between the struts (2, 2′) or the walls by means of a screw (29, 29′), that passes with play through a through hole (26, 26′) in the struts (2, 2′) or in the walls and that is screwed into threaded holes (38, 38′) in the transversal cross member.

6. The sled according to claim 1, characterized in that
the elastic tilt-pivot connection of the seat (10) relative to the transversal cross member (17) consists of at least one elastic element (22, 24) between the seat (10) and the transversal cross member (17), whereby the transversal cross member (17) has a through hole (20) in the center through which, as an axis, a screw (23) running in the direction of the longitudinal center axis (36) of the seat (10) passes, optionally with play, said screw being screwed into a threaded hole (35) in the seat (10), whereby the threaded hole (35) extends from the front end (37) of the seat (10) along the longitudinal center axis (36) thereof.

7. The sled according to claim 1, characterized in that
the struts (2, 2′) are oriented forward at a slant, and they divide each of the runners (1, 1′) into a front part (3, 3′) and a rear part (4, 4′), whereby each of the end areas (5, 5′) of the rear parts (4, 4′) of the runners (1, 1′) are angled upward at an angle (β) of more than 90° but less than 180°, thereby forming a turning and braking point (30, 30′) in the transition between the rear parts (4, 4′) of the runners (1, 1′) and the end areas (5, 5′) of the rear parts (4, 4′) of the runners (1, 1′) relative to the ground.

8. The sled according to claim 1, characterized in that,
in a perpendicular top view onto the runners (1, 1′), in order to hold the end of the seat (10) in the backward direction, the holders (6, 6′) of the runners (1, 1′) are situated behind the turning and braking points (30, 30′) of the runners (1, 1′), thereby forming a lever arm (1), or else the holders (6, 6′) coincide with the end points of the runners (1, 1′).

9. The sled according to claim 1, characterized in that
the counter-holders arranged at the ends on the rear end (13) of the seat (10) are bolts (14, 14′) that are oriented upward at a slant at an angle (α) of 0° to 45° relative to the crosswise axis (33) of the seat (10) or to the rear part (13) thereof, whereby the holders (6, 6′) that are on the runners (1, 1′) and that accommodate the bolts (14, 14′) are slanted at an equal angle relative to the ground.

10. The sled according to claim 9, characterized in that the bolts (14, 14′) run in a perpendicular projection at a right angle relative to the longitudinal center axis (36) of the seat (10).

11. The sled according to claim 1, characterized in that
the runners (1, 1′)—whose front ends (7, 7′) are angled upward at a slant—are each bent back toward the struts (2, 2′) so as to run upward at a slant in the form of a backward bend (8, 8′) and they are integrally connected to the struts (2, 2′), whereby the connecting parts between the backward bends (8, 8′) and the struts (2, 2′) are configured as holding bars (9, 9′).

12. The sled according to claim 1, characterized in that
the struts (2, 2′) are oriented upward and facing inward toward each other, whereby the runners (1, 1′) are likewise slanted with respect to each other in such a way that they only run on the inner edges of the runners (1, 1′).

13. The sled according to claim 12, characterized in that
the struts (2, 2′) as well as the runners (1, 1′) are slanted toward each other at an angle (α) between 0° and 45° from the vertical and/or are slightly convex in shape.

14. The sled according to claim 1, characterized in that
the bolts (14, 14′) are the ends of a crosswise axis (33) that extends at the rear part (13) of the seat (10) and that runs perpendicular to the longitudinal center axis (36) thereof.

15. The sled according to claim 1, characterized in that
the rear part (13) of the seat (10) is angled down toward the back in the form of an apron, whereby the bend (39) runs in a perpendicular projection in the area of the turning and braking point (30, 30′) of the runners (1, 1′) or else in the area of the bends of the end areas (5, 5′).

16. The sled according to claim 1, characterized in that
the runners (1, 1′) and the seat (10), and optionally also the transversal cross member (17), are all made of a material containing carbon fibers or glass fibers or both.
